(19) United States
(12) Patent Application Publication
(10) Pub. No.: US 2005/0016261 A1
(43) Pub. Date: Jan. 27, 2005

(54) Pressure checking apparatus for a swimming pool and method of use

(76) Inventor: James C. Yoncuski, Danville, PA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/626,032

(22) Filed: Jul. 23, 2003

(51) Int. Cl. G01M 3/28; G01M 3/32

(52) U.S. Cl. 73/40.5 R; 73/49.1; 73/49.2

(57) ABSTRACT

A method of leak checking a swimming pool having a water conducting system includes removing a skimmer device from an inlet pipe of a suction line of the swimming pool; removably engaging, for fluid exchange, a threaded nipple of an elongate pipe housing having at least 2.5 feet in length, into the inlet pipe; closing a return line and a drain line valves of the swimming pool; engaging a garden hose with a shutoff valve in the housing; applying water pressure to the garden hose; adjusting the shutoff valve to a pressure of approximately 15 psi in the housing, this pressure being common to a water pressure in the water conducting system of the swimming pool; closing the shutoff valve and noting a pressure level in the housing as read on a pressure gauge engaged with the housing; and repairing a leak in the swimming pool water conducting system when the pressure level thereafter drops.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to system pressure checking methods and devices and more particularly to a device and method of use for checking the integrity of a water conducing system of a swimming pool.

2. Description of Related Art

The following art defines the present state of this field:

Yoncuski, U.S. D470,064 teaches the design features of the subject invention.

Barker, U.S. Pat. No. 5,261,269 teaches a pool leak detector for use in combination with a pole having a proximal end to be used as a handle and a distal end to be submerged in the pool, the detector comprising means for providing a container of dye carried on the distal end with the container having exit port means for conveying dye from the container. Battery-operated actuating means for releasing dye from the container through the port means is provided, the actuating means comprising a battery pack for supplying electrical energy carried on the proximal end of the pole and an electrically-operated actuator carried on the distal end of the pole. The container is a collapsible container, and means for placing the container under load to eject dye from the exit port means is provided.

Bontempo U.S. Pat. No. 5,065,690 teaches a swimming pool leak detector for locating water leaks in a filled swimming pool from a standing position (when the depth of the pool allows) within the swimming pool. The leak detector is machined to resemble a billiard cue and consists of two main parts: a receiver and a plunger. The receiver is machined from a solid plastic rod with a reservoir at its broadest end to accommodate the plunger. A channel is drilled from the tip of the leak detector to the reservoir. The reservoir is filled by submerging the tip of the leak detector into a dye solution (food coloring) and pulling outwardly on the plunger which draws the dye solution into the reservoir. The user then enters the filled swimming pool with the filled leak detector and tests for leaks by placing the tip of the leak detector closely to the point of investigation. By pressing downward on the plunger, a small stream of dye is released, and if a leak is present at the point of investigation, the suction caused by the leak draws the dye solution to the leak, thus pin-pointing the problem.

The prior art teaches the use of leak detectors of various kinds including leaks in a swimming pool, and through standard approaches used by plumbers, the finding of leaks in plumbing joints and pipes. However, these techniques are not applicable to leak detection in a swimming pool piping system since most of the pipes are not accessible and a method is needed that is quick and highly accurate. The present invention fulfills these needs and provides further related advantages as described in the following summary.

### SUMMARY OF THE INVENTION

The present invention teaches certain benefits in construction and use which give rise to the objectives described below.

The present invention teaches a device and method of use of the device for leak checking a swimming pool plumbing system and includes removing a skimmer screen from a skimmer assembly at the suction line of the swimming pool and removably engaging, an elongate pipe housing having at least 2.5 feet in length for fluid exchange with the pool's plumbing system. Return line and a drain line valves are closed so as to isolate the plumbing system and the pipe housing. A garden hose feeds water under pressure of normally between 20 and 50 psi to the housing through a shutoff valve. The shutoff valve is adjusted to read between 10 and 15 psi in the housing, and of course this is common to the pool plumbing system. When the system has been pressurized, the shutoff valve is closed leaving the system at pressure. Over the next 5 minutes or so a pressure gauge on the pipe housing is watched and if pressure cannot be held by the system, the gauge shows its rate of decrease. From this it is possible to know roughly, the leak rate of the pool plumbing system.

A primary objective of the present invention is to provide an apparatus and method of use of such apparatus that provides advantages not taught by the prior art.

Another objective is to provide such an invention capable of easy installation and use.

A further objective is to provide such an invention capable of indicating a pressure decrease and rate of fall.

A still further objective is to provide such an invention capable of controlling detection pressure in a plumbing system.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is an elevational view of the preferred embodiment of the invention; and

FIG. 2 is a plumbing schematic diagram thereof showing relationship between the invention and a swimming pool plumbing system.

### DETAILED DESCRIPTION OF THE INVENTION

The above described drawing figures illustrate the invention in at least one of its preferred embodiments, which is further defined in detail in the following description.

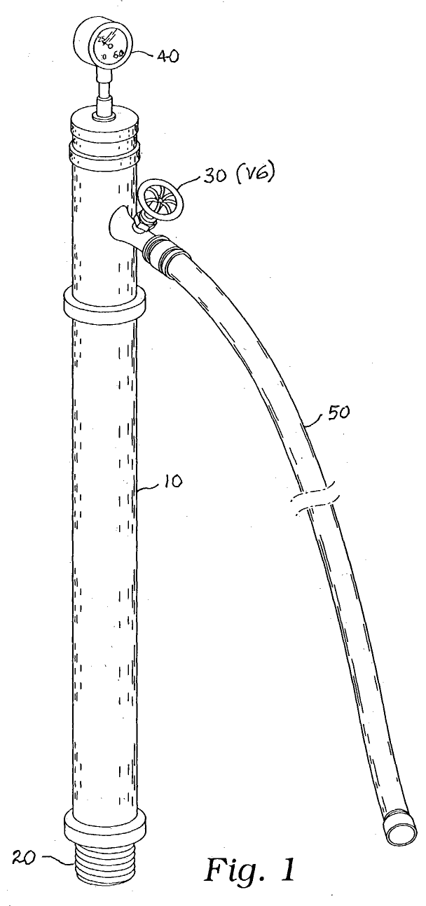

The present invention is a leak checking apparatus for a swimming pool 5. As shown in FIG. 1 an elongate pipe housing 10, of at least 2.5 feet in length, terminates at a distal (lower) end with a threaded nipple 20, and terminates at a proximal (upper) end with a shutoff valve 30 (V6) such as a common spigot found on the exterior of most houses, and a pressure gauge 40 calibrated for reading water pressure up to about 60 psi. The shutoff valve 30 is connected to a garden hose 50. The assembly, as described above is air tight with the exception of the open distal end of the housing through the threaded nipple 20 and the garden hose 50. Thus, when the nipple 20 is closed off and a source of water under pressure is connected through the garden hose 50, the interior of the pipe housing 10 is pressurized through the shutoff valve 30; assuming that valve 30 is open. The housing 10 is able to hold pressure under these conditions. The length of the pipe housing 10 of 2.5 feet or more is critical to the intended use of the invention. This allows the pipe housing 10 to easily reach into pool equipment and plumbing access opening and engage the nipple 20 with a receiving threaded hole (not shown) in the plumbing system of the pool 5. Typically the threaded hole used by the skimming device of the swimming pool is used for receiving nipple 20. It also allows the shutoff valve 30 and the pressure gauge 40 to be positioned so that the valve 30 is easily reached for control and the gauge 40 is easily read.

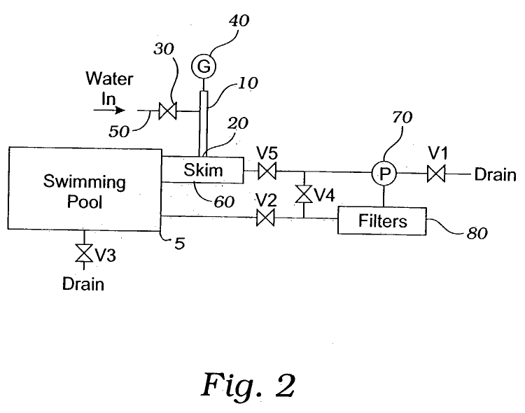

FIG. 2 is a schematic diagram of the invention and the pool plumbing system. Water is drawn from the pool through skimmer line 60 and through open system valve V5 by pool pump 70, and then flows through pool filters 80 and back to the pool 5 through open feed valve V2. During this process drain valves V1, V3 and V4 are closed and shutoff valve V6 is also closed.

When it is desired to leak check the swimming pool plumbing system, valves V1, V2 and V3 are maintained in the closed state, the nipple 20 of the present invention is threaded into the skimmer line 60 thereby sealing the plumbing system to pipe housing 10. At this time a skimmer device is temporarily removed. Alternately, the nipple 20 may be engaged with an inlet pipe of a suction line, shown by numeral 60, of the swimming pool 5. The present invention is thus engaging and further connected with a source of water under pressure, typically from a garden hose connected to the shutoff valve 30 (V6). With water from the garden hose 50 flowing into the housing 10, pressure is read on gauge 40. The shutoff valve 30 is closed until between 10 and 15 psi is indicated on the gauge 40. At this point shutoff valve 30 is fully closed leaving a static pressure of between 10 and 15 pounds in the pool's plumbing system and in the housing 10. If the static pressure shown by gauge 40 drops by more than a desirable amount, this indicates a leak in the pool's plumbing system.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A leak checking apparatus for a swimming pool, the apparatus comprising: an elongate pipe housing of at least 2.5 feet in length and terminating at a distal end with a threaded nipple and terminating at a proximal end with a shutoff valve and a pressure gauge; the shutoff valve connected to a garden hose.

2. A method of leak checking a swimming pool having a water conducting system, the method comprising the steps of: removing a skimmer screen at an inlet pipe of a suction line of the swimming pool; removably engaging, for fluid exchange, a threaded nipple of an elongate pipe housing having at least 2.5 feet in length, into the inlet pipe; closing a return line and a drain line valves of the swimming pool; engaging a garden hose with a shutoff valve in the housing; applying water pressure to the garden hose; adjusting the shutoff valve to a pressure of approximately 15 psi in the housing, this pressure being common to a water pressure in the water conducting system of the swimming pool; closing the shutoff valve and noting a pressure level in the housing as read on a pressure gauge engaged with the housing; and repairing a leak in the swimming pool water conducting system when the pressure level thereafter drops.
